(19) United States
(12) Patent Application Publication
(10) Pub. No.: US 2024/0329823 A1
(43) Pub. Date: Oct. 3, 2024

(54) ASYSTEM AND METHOD FOR MODULATING A GRAPHICAL USER INTERFACE (GUI) BASED ON REAL TIME STATUS CRITERIA

(71) Applicant: APP-POP-UP INC., Winnipeg (CA)

(72) Inventors: Rajeev KUMAR, Disraeli (CA); Rakesh KUMAR, Disraeli (CA)

(21) Appl. No.: 18/127,327

(22) Filed: Mar. 28, 2023

(51) Int. Cl. G06F 3/0487; G02B 27/01; G06F 3/01; G06V 40/16; H04N 21/6587; H04N 23/611

(52) U.S. Cl. CPC G06F 3/0487; G02B 27/017; G06F 3/013; G06V 40/176; H04N 21/6587; H04N 23/611; G02B 2027/0178; G06F 2203/04803

(57) ABSTRACT

A system for modulating a graphical user interface (GUI) comprises a user device in communication with a system controller. The user device comprises a display interface for displaying the GUI. The GUI defines a frame boundary a GUI size, and comprises content displayed via the display interface. The user device, the system controller and/or a synergistic combination thereof execute computer implementable steps for detecting a real-time status, determining the real-time status, and modulating the GUI on the basis of the determined real-time status. The real-time status is selected from the group consisting of a device user status, a device status, an auxiliary device status, a content status, and a combination thereof. The real-time status is determined based on status criteria stored within the memory of the system controller and/or the user device.

### TECHNICAL FIELD

The present disclosure generally relates to computer graphical user interfaces. More particularly, but not exclusively, the present disclosure relates to a system and method for modulating a graphical user interface (GUI) based on real time status criteria.

### BACKGROUND

A graphical user interfaces (GUI) is an interface through which a user interacts with electronic devices such as smart TVs, computers, tablets and smartphones through the use of icons, menus and other visual indicators or representations (graphics). A GUI is displayed via a display interface such as a display screen or a virtual screen created by the display screen of XR smart glasses for example. GUIs include the website being shown via a display interface or media windows streaming content and being positioned on a host GUI such as website as is known in various platforms like Facebook™ and YouTube™. While streaming content via a media window, the content is interrupted to stream other content such as an advertisement.

### Objects

An object of the present disclosure, there is provided a system for modulating a graphical user interface (GUI).

An object of the present disclosure, there is provided a method for modulating a graphical user interface (GUI).

### SUMMARY

In accordance with an aspect of the present disclosure, there is provided a system for modulating a graphical user interface (GUI), the system comprising: a user device comprising a device controller with an associated memory and a display interface for displaying the GUI, the GUI defining a frame boundary thereof further defining a GUI size, the GUI comprising content displayed via the display interface; and a system controller in communication with the user device, the system controller having a processor with an associated memory of processor executable code for being executed by the system controller or for being downloaded into the memory of the user device controller to be executed thereby or to be executed synergistically by a combination of the system controller and the device controller, wherein execution of the processor executable code by the system controller or by the device controller or by the combination thereof synergistically provides for the system controller or the device controller or the combination thereof with performing computer-implementable steps comprising: detecting a real-time status selected from the group consisting of a device user status, a device status, an auxiliary device status, a content status, and a combination thereof; determining the detected real-time status based on status criteria stored within the memory of the system controller and/or the user device; and modulating the GUI on the basis of the determined real-time status.

In an embodiment, the step of modulating comprises a step selected from the group consisting of: splitting the GUI into two or more sub-GUI portions positioned within the GUI frame boundary and providing for the two or more sub-GUI portions to simultaneously display respective content stored within the user device and/or hosted by the system controller and/or a same or different remote host controllers in communication with the user device; modulating the displayed content of the GUI; modulating the displayed content of the two or more sub-GUI portions following the step of splitting the GUI; and a combination thereof. In an embodiment, following the step of splitting the GUI, the step of modulating further comprises a step selected from the group consisting of: resizing at least one of the two or more sub-GUI portions; re-configuring at least one of the two or more sub-GUI portions; removing at least one of the two or more sub-GUI portions; and combination thereof.

In an embodiment, the user device comprises a sensor for detecting a user in detectable proximity to the device thereby detecting the real-time user status. In an embodiment, the sensor detects a sound of the user within the detectable proximity.

In an embodiment, the user device comprises smart glasses to be worn by the user, the smart glasses comprising at least one camera at an inner surface thereof for capturing images of an eye or eyes of the user, wherein the user status comprises an eye condition of the user. In an embodiment, the eye condition status of the user comprises a position of the eyes of the user, a direction of the eyes of user, a movement of the eyes of the user, a position of the eyelids of the user and a combination thereof. In an embodiment, the smart glasses further comprise an outer camera positioned at an outer surface of thereof for capturing hand movements of the user. In an embodiment, the device user condition comprises hand movements of the user

In an embodiment, the user device comprises a camera for capturing images of the device user within a field of view (FOV) of the camera to detect the real-time user status. In an embodiment, the device user status is selected from the group consisting of a user condition status, a user facial status, a user type status and a combination thereof. In an embodiment, the condition status is selected from the group consisting of a presence of the user within the FOV of the camera, a movement of the user within the FOV of the camera, a position of the user within the FOV of the camera, a size of the user within the FOV of the camera, an eye condition status of the user within the FOV of the camera and a combination thereof. In an embodiment, the position of the user is selected from a position of the body of the user, a configuration of the body of the user and a combination thereof. In an embodiment, the eye condition status of the user comprises a position of the eyes of the user, a direction of the eyes of user, a movement of the eyes of the user, a position of the eyelids of the user and a combination thereof. In an embodiment, the determining of the real-time detected user facial status comprises facial recognition of the user and wherein the stored status criteria comprises stored user profiles including registration of the face of the user for facial recognition. In an embodiment, the facial status of the user is selected from the groups consisting of an eye condition status of the user, a size of the face of the user, a position of the face of the user, a facial type of the user combinations thereof. In an embodiment, the user type status is selected from the group consisting of an age type status, a gender type status, a size type status, a species type status and combinations thereof.

In an embodiment, the device status is selected from the group consisting of: a position of the device, a location of the device, a motion of the device, a use of the device, and combinations thereof. In an embodiment, the use of the device is selected from the group of the device displaying content via the display interface, receiving user input commands.

In an embodiment, the auxiliary device status is selected from the group consisting of an established communication between an auxiliary device and the user device, an input command to the user device via an auxiliary device, and a combination thereof, wherein the auxiliary device is a physical device and/or a virtual device.

In an embodiment, modulating the displayed content is selected from the group consisting of pausing streamed content, switching from one given streamed content to another given streamed content, rewinding streamed content, fast-forwarding streamed content, recalling previously streamed content to be streamed again in real-time and combinations thereof.

In an embodiment, when the GUI is split into the two or more sub-GUI portions positioned within the GUI frame boundary it defines a multiple display GUI, wherein the computer-implementable steps comprise: undocking a selected one of sub-GUI portions from the multiple display GUI thereby spatially separating the undocked sub-GUI portion therefrom, the undocked sub-GUI portion defining its own separate boundary frame and being selectively movable along the display interface.

In an embodiment, the undocking is performed via a user input command thereof.

In an embodiment, the GUI comprises media content display window defining the boundary frame and being displayed on a host graphical user interface and the two or more sub-GUI portions comprise two or more sub-window portions, wherein the splitting step comprises splitting the media content display window into the two or more sub-window display portions positioned within the frame boundary of the media display window. In an embodiment, when the media window is split into the two or more sub-window portions positioned within the frame boundary thereof it defines a multiple display window, wherein the computer-implementable steps comprise: undocking a selected one of the sub-window portions from the multiple display window thereby spatially separating the undocked sub-window portion therefrom, the undocked sub-window portion defining its own separate boundary frame and being selectively movable along the host graphical user interface.

In an embodiment, the GUI prior to the splitting displays video game content with game input control images for receiving finger real or virtual touch input commands for game control wherein the input control images are displayed at respective given positions via the display interface, wherein the computer-implementable steps comprise maintaining the input control images at the same respective and given displayed positions via the display interface following the splitting of the GUI thereby overlying one or more of the two or more sub-GUI portions.

In an embodiment, the GUI comprises a framework, the computer-implementable steps further comprising: modulating the framework of the GUI thereby providing for the splitting thereof into the two or more sub-GUI portions and for providing for the two or more sub-GUI portions to simultaneously display the respective content.

In an embodiment, splitting the GUI into two or more sub-GUI portions positioned within the GUI frame boundary comprises decreasing the size of the GUI while correspondingly replacing the decrease in size by an increase in size of at least one new GUI wherein the decreased GUI comprises one of the two or more sub-GUI portions and the at least one new GUI comprises the other of the two or more sub-GUI portions.

In an embodiment, splitting the GUI into two or more sub-GUI portions positioned within the GUI frame boundary comprises inserting at least one new GUI within the GUI causing the GUI to be correspondingly reconfigured, wherein the reconfigured GUI comprises one of the two or more sub-GUI portions and the at least one new and inserted GUI comprises the other of the two or more sub-GUI portions.

The present application includes various GUI modulation technologies described in U.S. patent application Ser. No. 17/951,415 filed on Sep. 23, 2022, U.S. patent application Ser. No. 17/561,261 filed on Dec. 23, 2021, and U.S. patent application Ser. No. 17/443,563 filed on Jul. 27, 2021 all three of which are incorporated herein by reference in their entirety.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

The following drawings form part of the present specification and present disclosure. In the appended drawings:

FIG. 1 is a schematic representation of a system for modulating a GUI including a system controller in communication with a user device having a camera to capture status images within the field of view (FOV) thereof, in accordance with a non-restrictive illustrative embodiment of the present disclosure;

FIG. 2 a schematic representation of a user device with a display interface including a GUI showing displaying one type of content at A and switching to another content media window displaying main content and thumbnail windows for displaying other content via the media window when selected, the media window being split into two sub-window portions at B with one sub-window portion displaying the main content and the other sub-window portion simultaneously displaying the additional or auxiliary content in accordance with a non-restrictive illustrative embodiment of the present disclosure;

FIG. 3 is a schematic representation of a user device with a display interface including a single GUI for displaying main content at I and then being split at B into two sub-GUI portions respectively displaying main content and auxiliary content;

FIG. 4 is a schematic representation of a user device with a display interface including a host GUI including at A a media window displaying main content and thumbnail windows for displaying other content via the media window when selected, the media window being split into two sub-window portions at B with one sub-window portion displaying the main content and the other sub-window portion simultaneously displaying the additional or auxiliary content in accordance with a non-restrictive illustrative embodiment of the present disclosure;

FIG. 5 is a schematic representation of the user device of FIG. 4 with one of the sub-window portions at B of FIG. 4 being undocked from the other one of the sub-window portions in accordance with a non-restrictive illustrative embodiment of the present disclosure;

FIG. 6 is an enlarged view of the split GUI at B of FIG. 4 in accordance with a non-restrictive illustrative embodiment of the present disclosure;

FIG. 7 a schematic representation of a user device with a display interface including a GUI displaying video game content including input command images at I, the GUI being split into two sub-GUI portions at II, with one sub-GUI portion displaying the video game content and the other sub-GUI portion simultaneously displaying the additional or auxiliary content and with the input command images being in the same position as in I, in accordance with a non-restrictive illustrative embodiment of the present disclosure;

FIG. 8 is a perspective front view of a user device in the form of smart glasses such as XR glasses in accordance with a non-restrictive illustrative embodiment of the present disclosure;

FIG. 9 is a rear view of the smart glasses of FIG. 1, in accordance with a non-restrictive illustrative embodiment of the present disclosure;

FIG. 10 is a schematic representation of the virtual screen including a GUI produced by the smart glasses of FIG. 8, in accordance with a non-restrictive illustrative embodiment of the present disclosure;

FIG. 11 is a schematic representation of a virtual screen produced by the smart glasses of FIG. 8 mixed with the real surrounding environment, in accordance with a non-restrictive illustrative embodiment of the present disclosure;

FIG. 12 is the schematic representation of the virtual screen within the real surrounding environment of FIG. 11 with the GUI being split into two sub-GUI portions, in accordance with a non-restrictive illustrative embodiment of the present disclosure;

FIG. 13 is the virtual screen within the real surrounding environment of FIG. 12, with one of the sub-GUI portions being undocked from the other sub-GUI portion, in accordance with a non-restrictive illustrative embodiment of the present disclosure;

FIG. 14 is a schematic representation of a sequential modulation of an assembled multiple window display on a host GUI with two sub-window portions at sequence or step image (i), one of the sub-window portions is undocked from the other sub-window sub-portions at sequence or step image (ii), the undocked sub-window portion partially overlies the other sub-window portion portions at sequence or step image (iii), the overlying sub-window portion is ingested by the other sub-window portion at (iv), in accordance with a non-restrictive illustrative embodiment of the present disclosure;

FIG. 15 is a schematic representation of sequential splitting of a GUI displayed via a screen on a user device showing various time stamps of the splitting from α-δ, in accordance with a non-restrictive illustrative embodiment of the present disclosure;

FIG. 16 is a schematic representation of a user device with a screen displaying a GUI and a user's hand in front of the screen for modulating the GUI without touching the screen, in accordance with a non-restrictive illustrative embodiment of the present disclosure; and

FIG. 17 is a side view of the schematic representation of FIG. 16 showing a user in front of the user device pointing to the screen from a distance for modulating the GUI without touching the screen, in accordance with a non-restrictive illustrative embodiment of the present disclosure.

### DETAILED DESCRIPTION OF ILLUSTRATIVE EMBODIMENTS

Generally stated, and in accordance with an embodiment an aspect of the present disclosure, there is provided a system for modulating a graphical user interface (GUI). The system comprises a user device comprising a device controller with an associated memory and a display interface for displaying the GUI. The GUI defines a frame boundary thereof further defining a GUI size, the GUI comprising content displayed via the display interface. A system controller is in communication with the user device. The system controller has a processor with an associated memory of processor executable code for being executed by the system controller or for being downloaded into the memory of the user device controller to be executed thereby or to be executed synergistically by a combination of the system controller and the device controller. Execution of the processor executable code by the system controller or by the device controller or by the combination thereof synergistically provides for the system controller or the device controller or the combination thereof with performing computer-implementable steps comprising. One of the steps is detecting a real-time status selected from the group consisting of a device user status, a device status, an auxiliary device status, a content status, and a combination thereof. One of the steps is determining the detected real-time status based on status criteria stored within the memory of the system controller and/or the user device. One of the seps is modulating the GUI on the basis of the determined real-time status.

In an embodiment, the real-time status criteria are criteria related to the status of the user, the status of the user device, the status of an auxiliary device, the status of displayed content and combinations thereof as will be further described herein.

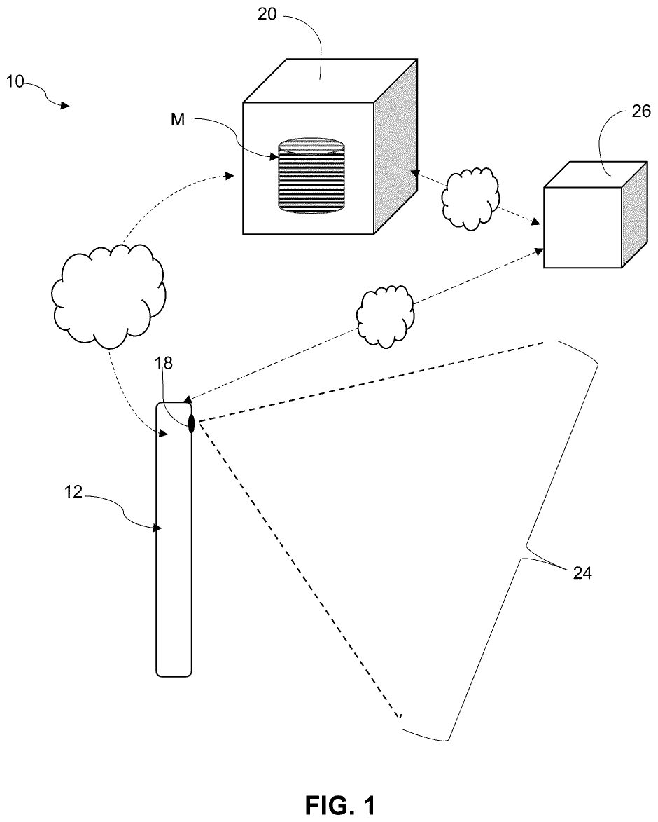

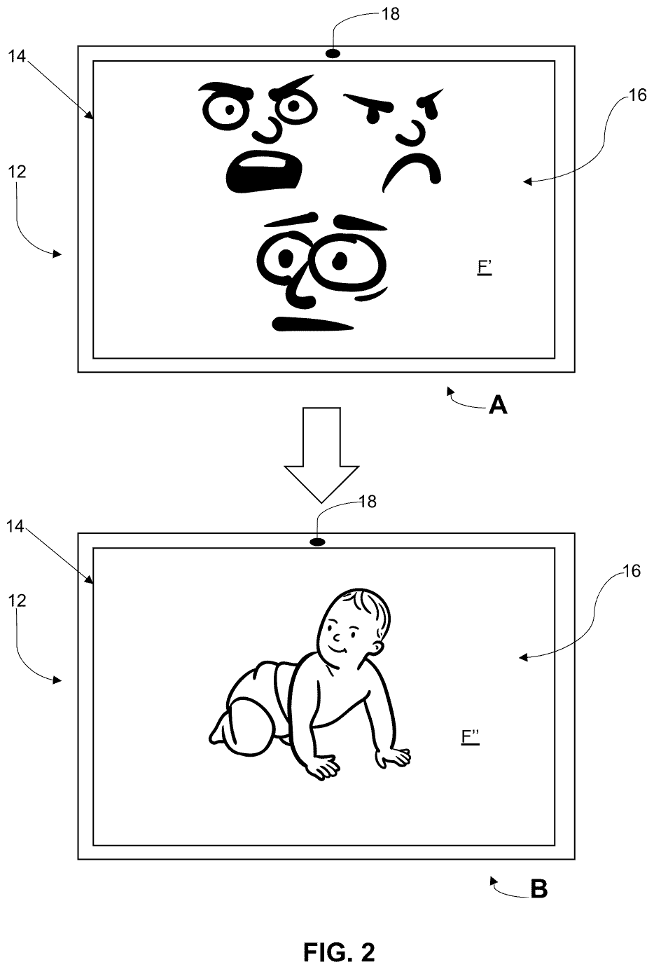

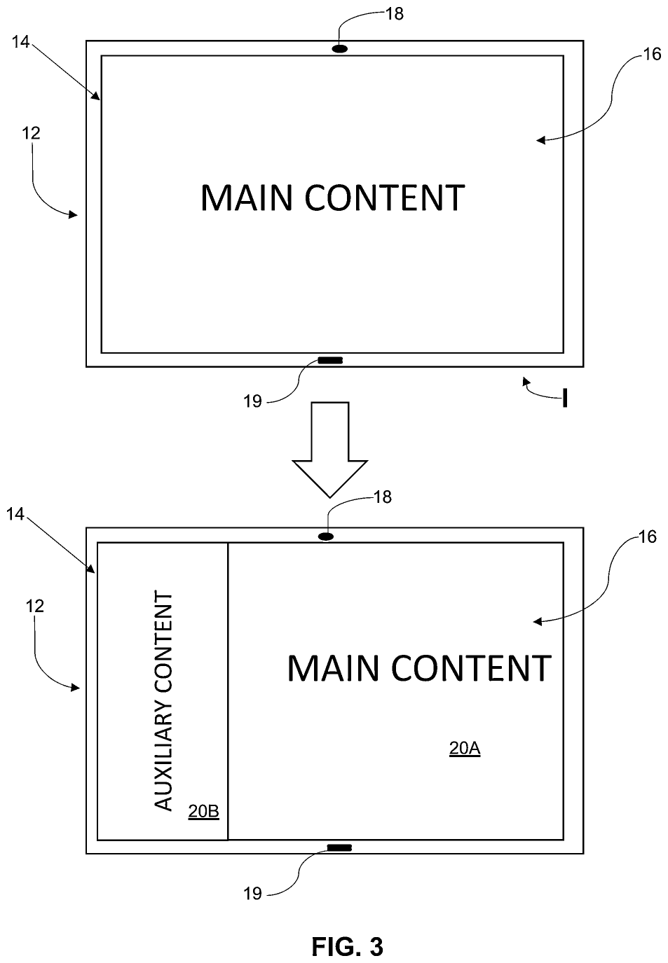

FIG. 1 shows a system 10 for modulating a graphical user interface (GUI). With reference to FIGS. 2 and 3, the system 10 provides for a user device 12 such as a smart TV in the examples shown here (or other devices such as tablets, PCs, smartphones etc.) to modulate the GUI. The user device 12 includes a display screen 14 for displaying a GUI 16 as well as a camera 18.

Turning back to FIG. 1, the camera 18 of the user device 12 captures images within its field of view (FOV) 24 thereby providing for monitoring the user looking at the screen 14 within the FOV 24. The images (e.g., contiguous, or intermittent video, still shots, time stamps etc.) captured by the user device 12 via the camera 18 are transmitted to a system controller 20 for analysis. The system control 20 has a memory M of predetermined parameters to modulate the GUI as provided herein based on the predetermined parameters. For example, when content is being streamed and displayed via the display screen 14, the controller 20 is aware if the actual content is being viewed by the user or if the user is not in front of the screen or if another individual rather than the assigned user is now in front of the screen 14. This is more common with wall mounted user devices 12 such as smart TVs for example, where individuals enter and leave a room in the course of content being streamed.

In the example of FIG. 2, the GUI 16 comprises streamed content such as a film F′ (shown at A) which is age inappropriate for youngsters as it includes aggressive scenes. If a youngster is within the FOV 24, the system 10 provides for changing the age inappropriate displayed content F′ to age appropriate content F″ (shown at B).

In the example of FIG. 3, the GUI 16 display main content (at I) which is split when the system determines that a user is viewing the screen 14 into two sub-GUI portions 22A and 22B, which sub-GUI portion 22A showing the main content and sub-GUI portion 22B showing auxiliary portion.

The system controller 20 executes the computer implementable step of providing users to set and modulate various GUI modulating parameters and store these parameters in the memory M of the controller 20 or the memory of the display device 12 via input commands. For example, in a family, individual profiles can be set up with images of the individuals thereby identifying the assigned individuals who are the primary users of the device 12, for example the parents and other adult relatives. Children in the home are also identified and their profiles and images are stored in the device 12 or system controller memory M. Thus, the system controller 20 of device 12 can thus detect which individual or individuals are viewing the display screen 14 during content streaming via facial recognition. In the cases where the identity of the individual has not been stored, the system controller or the device 12 can assess what type of individual is in front of the screen 14, for example it can differentiate between a baby, an animal (dog, cat), an older child and an older individual (i.e., adult) via preprogrammed parameters or artificial intelligence (AI) machine learning.

For example, if the user device 12 (e.g. smart tablet, wall mounted smart TV, smartphone etc.) is on and is streaming a film and the viewer (or assigned user) is currently viewing, the system controller 20 receives the event status of the viewer/user. In this example, the controller 20 is in a network communication with a given third party server, generally denoted 26 which provides the content (movie, sporting event etc.) being streamed via the display screen 14. Having detected that the viewer/user is indeed watching the streamed content, the controller 20 will execute the computer implementable step of splitting the GUI to provide for an auxiliary GUI portion for streaming an advertisement for example. Indeed, the advertising content may be provided by the same or another given third party server 26 or by the controller 20 in certain cases.

Detecting the status of the viewer/user via the camera 18 as provided herein includes facial recognition or type recognition by the system controller 20. The foregoing parameters having been already preprogrammed in the memory M of the system controller 20 or acquired via AI and machine learning. Thus, the type of advertising content selected by the system controller 20 can be directed to a given individual based on face recognition or based on type recognition (gender assessment, age group assessment and the like).

In an embodiment, the main content being streamed via the GUI 16 (independent of any splitting of the GUI 16) is modulated based on viewer status including without limitation, the facial status, the type status, the condition status.

The facial status includes face recognition and as such, GUI modulation is based on which given individual of a predetermined set of previously identified individuals (for example, those who have uploaded user profiles) are viewing the screen display 14 in real time.

The type status includes viewer type recognition i.e. what type of individual is viewing; for example, the viewer belongs to a given type category that has been pre-categorized and stored in the memory M of the controller 20. A type category may include for example a gender category, an age category, a height category, a species category (i.e. is the viewer an actual person or a pet etc.).

The condition status of the individual includes the presence or non-presence of the individual, whether the individual is awake or asleep, whether the individual is seated in front of the user device 12 or standing or moving around (thus not currently paying attention), whether the individual is having a conversation with someone, or whether the individual is present, non-present, sleeping, standing, reading, on the phone, in a conversation without looking at the screen. Indeed, the 18 can monitor the eyes of the viewer as described for example in U.S. Ser. No. 17/443,563 in order to determine if the viewer is indeed paying attention to the screen or not. The condition status therefore includes the eye condition status such as the direction of the eyes or the position of the eyelids (open, closed, partially open/closed etc.).

Thus, the controller 20 can execute the computer implementable step of modulating the GUI 16 to either modulate the GUI depending on the viewer status. Modulation of the GUI includes splitting the GUI so as to provide simultaneous streaming of auxiliary content with main content, pausing the stream of the GUI (or portions thereof, if it has been split), restarting a paused stream of the GUI or sub-GUI portions thereof, increasing the volume of the stream of the GUI or sub-GUI portions thereof, streaming or not streaming certain content via the GUI or sub-GUI portions thereof, replacing one stream by another stream of the GUI or sub-GUI portions thereof, turning off the GUI or sub-GUI portions thereof or otherwise blacking out the GUI or sub-GUI portions thereof, changing the dubbed language of a stream or the closed captioning/subtitling, rewinding, fast-forwarding or continuing a stream and the like.

Modulation based on viewer status of the GUI or of the multiple simultaneous GUIs as provided herein will be further described by way of the following non-limiting examples. If a viewer turns their smart TV on but is not present, the controller 20 can modulate the GUI to pause the stream and re-start once the viewer is again present and viewing the screen 14. The controller 20 can pause the stream when the user is not sufficiently paying attention to stream and is instead walking around or on the phone or sleeping. The controller 20 can pause the stream when the viewer is on the phone or not sufficiently paying attention and then rewind it for a few minutes and restart it once the viewer has ended their call or has returned their full attention to the screen 14.

In the case that the viewer is awake but not sufficiently paying attention the controller 20 can modulate the GUI to increase the volume of the stream or decide to split the GUI to provide auxiliary content (such as an advertisement) in the GUI or a sub-GUI portion and increase the volume of the auxiliary content while pausing the main content in the main sub-GUI portion to stop the stream. Indeed, when the viewer is actually watching the display screen 14, the controller 20 will provide adequate auxiliary content in the GUI, following switching to auxiliary content from the main content or in the sub-GUI portion, following splitting.

The auxiliary content streamed in the GUI or a sub-GUI portion can be selected from a variety of content selections stored in the memory of the controller or otherwise available to the controller 20 via a third party server 26 based on the viewer status. For example, advertisements directed to children, teens, adults, and seniors will be displayed to the proper audience. As such, when a child is watching the controller 20 will stream ads related to toys via the GUI or a sub-GUI portion following splitting, when a grandparent is watching appropriate medical advertisements will be streamed via the GUI or the sub-GUI portion and so on a so forth.

Parents can set profile parameters for their children and as such, when a child enters the FOV 24 of the camera 18, the system controller 20 can remove inappropriate streams from the GUI and replace them by appropriate ones (such as in the example of FIG. 2), or not allow a minor to view certain programs by blocking the stream or by blacking out the GUI and closing the volume. The system controller can also send a signal such as an email direct message to a parent that a minor is trying to access non-authorized streams or simply keep a data log accessible to the parents for example. Indeed, if a viewer tries to bypass the controller 20 by turning off the camera 18, the system controller 20 will not allow the device 12 to stream.

In another embodiment, the camera 18 may act as a security camera turning the device 12 on to set off an alarm or to communicate with a third party user or with the user via another device. For example, an identified viewer may enter the FOV 24 during hours of the day where the device 12 (such as smart TV in this case) is not to be used.

With facial recognition, the controller 20 can provide appropriate auxiliary content (such as advertisements) to the viewer based on the viewer's registered profile or browsing history which is kept in the memory of the device or in the memory of the controller 20 or a combination thereof.

In another example, the controller 20 may change the language (dubbing, closed captioning/subtitles) based on the identity of the user.

In an embodiment, the viewer status is detected by the viewer input commands via the GUI 16. For example, if the viewer is tapping/touching the display screen 14, or is typing via a keyboard, or is pressing a remote control or on a keypad or is clicking via a mouse, this is indicative of the presence and attention of the viewer and thus GUI modulation is useful as this time and this modulation includes for example allowing certain content to be streamed for example, as main content is streamed, the GUI can switch from the main content to auxiliary content (such as a commercial), modulation also includes splitting of the GUI which allows auxiliary content to be streamed or displayed via a sub-GUI portion.

In an embodiment, viewer status is detected by a sensor 19 (see FIGS. 2 and 3) instead of a camera 18 which can detect the presence or absence of the user in front of the display screen 14 during content streaming. Thus, modulation such as switching the content being displayed or splitting can be effectuated during the presence of the viewer.

As mentioned above, the modulation of the GUI can also be based on voice input commands and thus the viewer can modulate the above via voice command if the viewer is authorized to modulate as per their user profile. Thus, users can request for their smart TV to pause, rewind, fast forward and change channels as well as split the GUI to access auxiliary content and the like. Indeed, when a viewer isn't paying attention or is not present in the FOV 24, a stream can be paused automatically for example.

In an embodiment, rather than the system controller 20 executing the computer implementable steps of modulating the GUI, the application therefor is downloaded from the controller 20 to the user device 12 and stored in the memory thereof, as such, the device 12 can split the GUI block or display content as explained above. Indeed, the foregoing can also be accomplished by synergistic relationship between the controller 20 and the user device 12. For example, GUI splitting is performed at the device 12 level and content type control is performed at the controller 20 level. Hence, the system controller 20 and the user device 12 can both modulate certain aspects of the GUI as defined herein.

In an embodiment, the system controller 20 or the device 12 detects the content type being displayed via the GUI and modulates the GUI based on the current content type being displayed. For example, if a user is using a particular app on their smart phone or other device 12 and they receive an audio or video call rather than replacing the app GUI by the call GUI as is known in the art, the currently displayed GUI is split with one sub-GUI portion containing the main content (the app GUI currently being used) and the other sub-GUI portion containing the auxiliary content (the incoming call GUI). In another embodiment, the streamed content being displayed is paused and the call can be notified to the user without splitting. If the user takes the call, the stream continues to be paused and once the call is finished, the streamed content re-starts continues from where it was paused.

In an embodiment, the system controller 20 or the device 12 detects the user device status such as position, location or movement.

In one example regarding the user device position status, when the user device 12 is a smartwatch, when the user has their arm in a generally vertically directed position, they are not currently looking at the display 14 and thus, there is no need to display auxiliary content (such as advertisements) When the user wants to look at their smartwatch the device 12 is in the generally horizontal directed position and thus the GUI can switch to auxiliary content. Moreover, when the user has their arm in a generally vertically directed position, they are not currently looking at the display 14 and thus, there is no need to split the GUI. When the user wants to look at their smartwatch, the device 12 is in the generally horizontal directed position and thus the GUI can be split to display auxiliary content.

In one example regarding the device location status, the user may be carrying with them a smart device 12 (phone, tablet etc.) and the GUI may interrupt the main content it is currently displaying to display content that is relevant to the location status or alternatively the GUI splits to display auxiliary content in one sub-GUI portion thereof and the main content in another sub-GUI portion thereof when the device 12 is in a physical predetermined proximity to a given location. For example, the user may be near a museum of interest the and the GUI may display containing information about the museum or how to book tickets or particular expositions on the day or alternatively the GUI may be split to allow auxiliary content to be displayed containing information about the museum or how to book tickets or particular expositions on the day. If the user is near a given commercial location, the GUI displays content regarding this given commercial location (advertisement, special offers, purchasing platforms etc.) or the GUI is split to display auxiliary content regarding this given commercial location (advertisement, special offers, purchasing platforms etc.) in a sub-GUI portion. Thus, system participating merchants can request that the controller system 20 display their additional or auxiliary content via the user devices 12 when the user devices 12 are in proximity to given locations. The users can modulate their profiles to have the additional or auxiliary content of the participating merchants be displayed accordingly. The users can also modulate their profiles to have the GUI display or be split to display auxiliary content in a sub-GUI portion as provided in U.S. patent application Ser. No. 17/459,702, which is incorporated by reference herein in its entirety. In an embodiment, location may be determined by GPS application stored in the memory of the user device 12.

In one example, regarding the device movement status, the GUI is modulated based on the speed of the user device 12. For example, the user device 12 may be in a vehicle and the GUI will only display content or auxiliary content via the GUI or alternatively be split to display auxiliary content in a sub-GUI portion when the vehicle is under a certain speed or at a constant speed such as an auto-pilot or the vehicle has stopped.

In an embodiment, the GUI is modulated based on a user device application status. For example, if a user is accessing a given application on their device or a virtual application (as provided in U.S. Ser. No. 17/459,702), the GUI displays auxiliary content by switching from the main content or be split to provide auxiliary content to be displayed in a sub-GUI portion. For example, when viewing a map app on a smartphone, the GUI is split to provide links to commercial establishments in the section of the map the user is viewing or simply pops up the links in the GUI rather than splitting.

In an embodiment, the system controller 20 or the device 12 detects an auxiliary device status. The auxiliary device may be a smart TV remote control, a game console, a virtual machine and the like as can be contemplated by the skilled artisan within the scope. The use of the auxiliary device is indicative of the fact that the user is viewing the steamed content and thus GUI modulation such as switching form the main content to display auxiliary content or splitting the GUI is now useful.

As previously mentioned, GUI splitting is also providing for simultaneously viewing and interacting with two or more separate applications.

In an embodiment, GUI splitting is performed based on the position of the user device 12. For example, when a tablet or a smartphone is moved from the landscape to the profile position, the screen auto-rotates therewith. As such, the GUI can be split into side by side portions or top and bottom portions for example depending on the position of the device 12.

In an embodiment, the system controller 20 will execute splitting upon a request from a third party server to display auxiliary content to a user via the user device 12 without interrupting the main content.

In an embodiment, the system controller 20 upon a request from a third party server to display auxiliary content to a user via the user device 12 will pause the main content, display the auxiliary content via the GUI and then return to the main content which continues from where it was paused.

In an embodiment, the system controller 20 executes the computer implementable step of allowing a user to recall content via the GUI. For example, as the user is viewing main content on their GUI, and the main content is interrupted with auxiliary content displayed via the same GUI (for example a TV show being interrupted by a commercial); the auxiliary content is displayed for a short time frame (e.g., 5 sec-25 sec) and then the GUI switches back to the main content. The user via input commands therefore through the device interface can request from the system controller 20 to re-display the auxiliary content. This is convenient for advertisements that are streamed too quickly. The user can thus even via input commands therefor go to a purchasing web-page from the streamed advertisements within the GUI or a sub-portion thereof to peruse more information about the products and services being advertised and/or make a purchase.

In an embodiment, the system controller 20 executes the computer implementable step of allowing a user to recall content via an auxiliary content displayed via a sub-GUI portion. For example, as the user is viewing main content on their GUI, the GUI is split to provide at least two sub-GUI portions, one of the sub-GUI portions continues to display the main content without interruption and the other of the sub-GUI portions displays the auxiliary content which is an advertisement for example. The auxiliary content is displayed for a short time frame (e.g., 5 sec-25 sec) and then the sub-GUI portion displaying this auxiliary content closes while the other sub-GUI portion enlarges to take the space of the original GUI displaying the main content without interruption. The user via input commands therefore through the device interface can request from the system controller 20 to re-display the auxiliary content. This is convenient for advertisements that are streamed to quickly. The user can thus even via input commands therefore go to a purchasing web-page from the streamed advertisements within the same sub-GUI portion to peruse more information about the products and services being advertised and/or make a purchase.

In an embodiment, when auxiliary content is being displayed in a sub-GUI portion, the main content displayed in the other sub-GUI portion may be paused and/or rendered inaccessible to receive user input commands.

The examples shown herein show devices 12 with display screens 14 which provide a two-dimensional GUI 16 as is very well known for laptops, desktops, tablets and handheld devices.

A graphical user interface or GUI is both the program being hosted on server for being displayed and the display itself. The terms interface and GUI are interchangeable. An interface portion or a GUI portion is a portion of the overall GUI being displayed through the same screen. Yet an interface portion is also a separate GUI unto itself. An interface display is the interface being displayed through a device display (e.g. screen). An interface display portion is a part of the over visual frame or interface that hosts a separate GUI. Each interface display portion displays its own GUI (i.e. content). The content can be a stream, a video, a video game, or another interactive GUI etc. In essence, the visual display of the screen is being split into separate displays with respective content that are independent from one another much like having multiple devices with respective screens. Yet, in this case multiple content can be viewed via the same screen. Separating, dividing, or splitting the screen/interface can also be referred to as resizing the screen/interface wherein the main content being shown in the full screen is resized to become smaller as to fit another one or more interface display portions with respective content for simultaneous display via the same screen. Resizing also includes enlarging a given interface display portion to the full size of the interface display provided by the screen while removing the other portions and thus the resized portion becomes the interface display displaying its own and the sole GUI rather than multiple GUIs. Of course, resizing also includes reducing the size of main content running in the full screen (interface display) to be displayed in a smaller portion of the display thus allowing for other interface display portions to simultaneously run other content.

Generally, a framework is a layered structure indicating what kind of programs can or should be built and how they would interrelate. GUIs are built on a framework. In an embodiment, the framework of the GUI is modulated (modified, changed, replaced etc.). In an example, the system controller 20 executes the computer implementable step of modulating the framework of the user interface 16. Indeed, the system controller 20 modifies the interface software framework running on the user device 12 (i.e., stored within the memory thereof). In an embodiment, the system controller 20 adds or changes the interface framework of the user device 12. The foregoing provides for simultaneously displaying more than one content streams. The foregoing is provided by splitting a media window in a GUI into two or more media sub-windows.

In an embodiment, the system controller 20 provides for the user device 12 to download an application in its memory providing the user via user input commands to split the screen as defined herein or splitting the GUI of a media window in a GUI. In an embodiment the system controller 20 provides for the user device 12 to download an application in its memory providing the user via user input commands to resize the GUI or portions thereof (following splitting) as provided herein. In an embodiment, the foregoing application is contained within another application. Thus when a user wishes to download a given app they concurrently download into their device the application allowing their device to displaying multiple graphical user interfaces via the same display as provided herein and to modulate the multiple graphical user interfaces as provided herein.

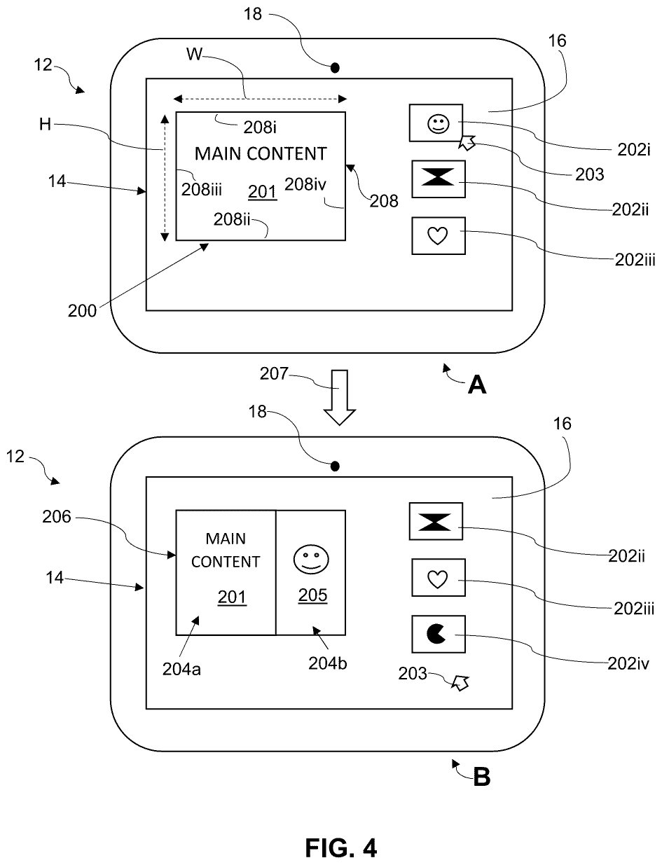

As previously explained the media window is a GUI which can be positioned within a larger GUI (a host GUI). For example, and as shown in FIG. 4, a user device 12 has a display interface such as a display screen 14 with a user interface 16 or GUI displaying a video streaming website (i.e. the host GUI) for example including a media window 200 displaying currently streaming content (or main content 201) and thumbnails or icons 202i, 202ii, 202iii for selecting other content. The user can input a command (such as a click by a cursor 203 for example or by other input commands as explained herein) to one of the thumbnails or icons (e.g. 202i) to watch additional/auxiliary content 205 with the main content 201. Instead of the window 200 replacing the main content 201 streamed by the content 205 related to the selected thumbnail 202i (as is known in the art), the window 200 at A is split (separated/subdivided) at step 207 into two sub-windows 204a and 204b at B thereby forming together a multiple display window 206. One sub-window 204a continues to display the main content 201 and the other sub-window 204b concurrently displays the content 205 of icon 202i. Splitting can be done automatically via the system controller 20 or by way of a user input command or user event as will be further discussed below. The application for splitting can also be downloaded from the system controller 20 into the memory of the user device 12.

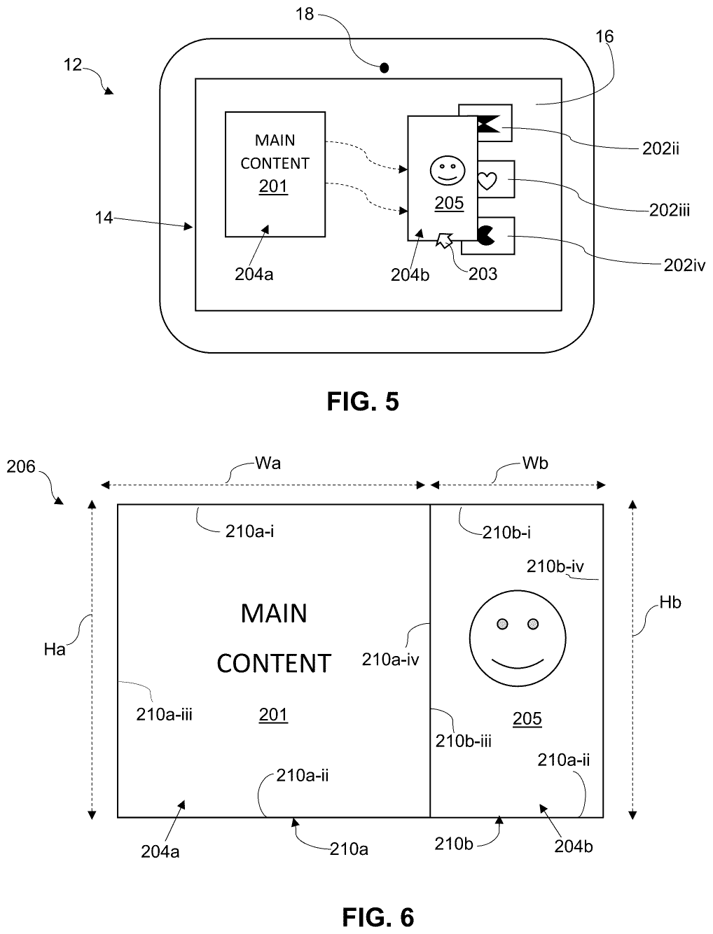

Turning to FIG. 5, one of the sub-windows, for example 204b can be undocked (spatially removed) from the multiple display window 206 and moved along the GUI 16 to another position thereby becoming in essence an independent media window and consequently providing for sub-window 204a to also become an independent media window thereby dismantling/disassembling the multiple display window 206. As such, the GUIs 204a and 204b can be spatially separated from one another along the width and height span of the GUI 16. Indeed, the undocked independent media 204b is provided to overlap on the rest of the GUI 16 (including the thumbnails 202ii, 202iii, 202iv), which in this case is an example of a media streaming website as known in the art. Indeed, the GUIs 204a and 204b can be adjoined together or re-docked to again form the multiple display window 206 hence becoming sub portions thereof once again.

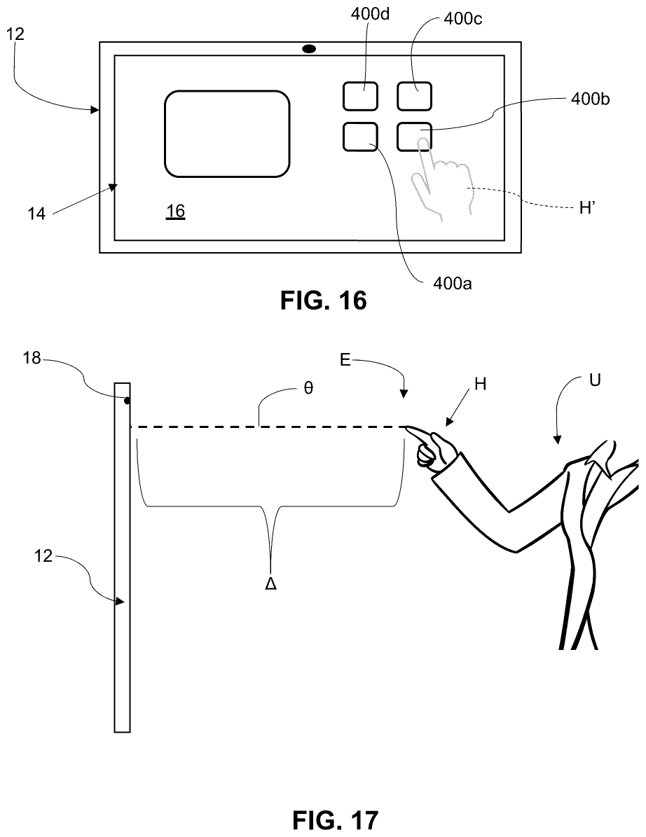

The system controller 20 provides for undocking the media window display 200 from its position on the media streaming website 16 and positioning it elsewhere on the GUI overlapping (i.e. covering) any contents thereunder as shown in the example of FIG. 16 where a media sub-window 204b covers the thumbnails 202ii, 202iii, 202iv.

The system controller 20 can provide the foregoing GUI modulation capabilities to the user device 12 via an application that is downloaded on the user device 12 providing the user to modulate media windows and sub-windows as provided herein via input commands therefor.

Turning back to FIG. 4, the media window 200 defines a height H and a width W. Indeed, the media window 200 usually has a rectangular configuration. The media window 200 comprises an outer frame 208 having a vertical top and bottom borderlines 208i and 208ii and lateral side borderlines 208iii and 208iv. When the media window 200 is split (separated/divided) to provide for sub-windows it transitions to the multiple display window 206 as shown in FIGS. and 17 maintaining the same outer frame 208, height H and width W thereof.

With reference to FIG. 6, each sub-window 204a and 204b defines a respective height Ha and Hb and a respective width Wa and Wb. The media sub-windows 204a and 204b usually have a respective rectangular configuration. The media sub-windows 204a and 204b comprise respective outer frames 210a and 210b having respective vertical top borderlines, 210a-i, 210b-i, respective bottom borderlines 210a-ii, 210b-ii, respective first side borderlines 210a-iii, 210b-iii and respective second side borderlines 210a-iv, 210b-iv.

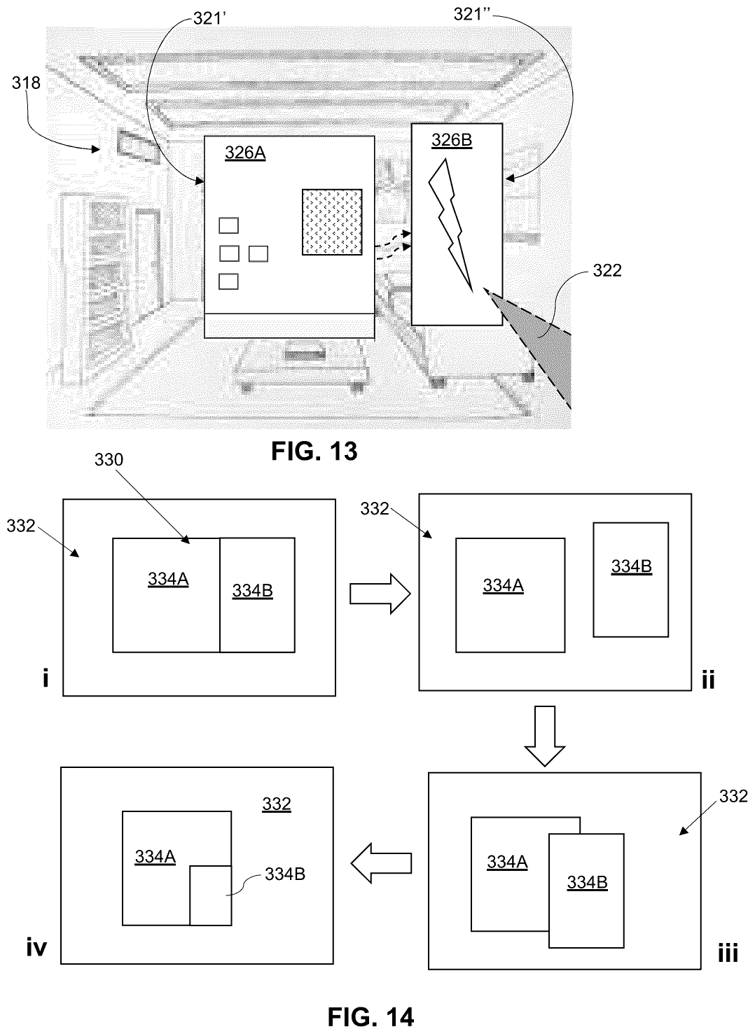

The multiple display window 206 shown in FIG. 6 the configuration of sub-windows 204a, 204b (and further sub-windows) can be modified within the multiple display window 206 having the same frame 208, height H and width W in a manner that is similar to the non-limiting examples shown in FIGS. 13a to 14 for the various interface portions.

The system controller 20 can provide the foregoing GUI modulation capabilities to the user device 12 via an application that is downloaded on the user device 12 providing the user to modulate media windows and sub-windows as provided herein via input commands therefor.

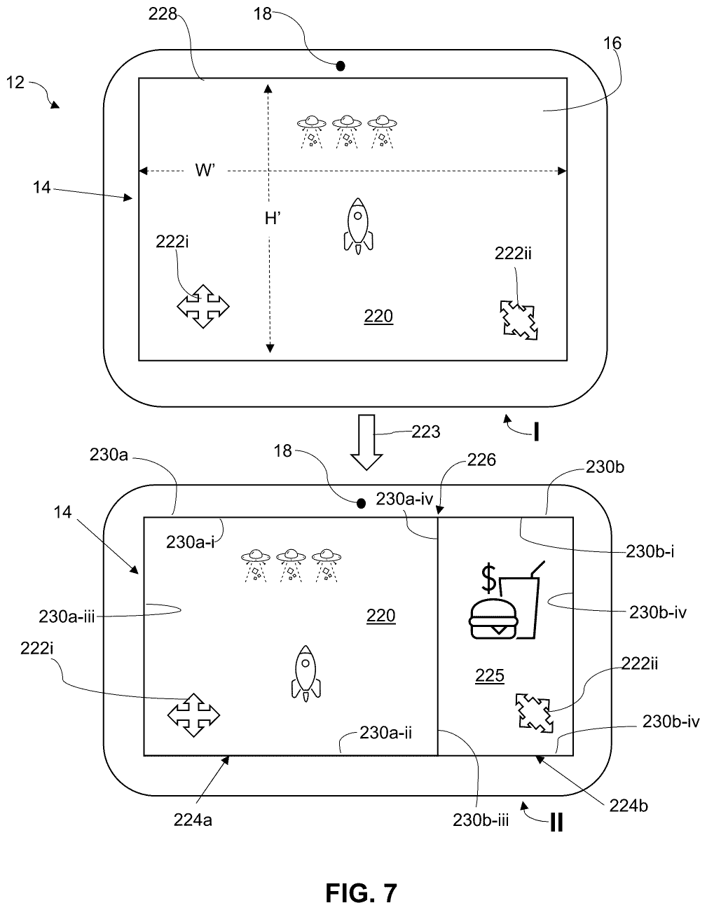

FIG. 7 shows the user device 12 with the display 14 screen displaying the GUI 16 which in this example comprising an online video game stream content 200. The online video game content 220 includes icons 222i and 222ii which are input command images or controls for playing the game. As such, the user can hold the device 12 in the form of a tablet or mobile phone and play the game with their thumbs for example touching the input command images 222i and 222ii as is known in the art for a variety of games.

When the GUI 16 splits at step 223 the online game content 220 (i.e., the main content) at I continues uninterrupted in a sub-GUI portion 224a and II and auxiliary content 225 is streamed in an adjacent sub-GUI portion 224b at II thereby together forming a divided or split GUI 226 with independent sub-GUI portions 224a, 224b thereof. The GUI 16 in the example of FIG. 7, defines a height H′ and a width W and comprises an outer frame 228 having a vertical top and bottom borderlines 228i and 228ii and lateral side borderlines 228iii and 228iv. When the video game GUI is split (separated/divided) to provide for sub-GUI portions 224a, 224b it transitions to the divided or split GUI 226 maintaining the same outer frame 228, height H′ and width W thereof. Each sub-GUI portion 224a and 224b defines a respective height and a respective width similar to the GUIs 204a, 204b previously discussed and shown in FIG. 6. The sub-GUI portions 224a and 224b comprise respective outer frames 230a and 230b having respective vertical top borderlines, 230a-i, 230b-i, respective bottom borderlines 230a-ii, 230b-ii, respective first side borderlines 230a-iii, 230b-iii and respective second side borderlines 230a-iv, 230b-iv.

In the example of FIG. 7, the input command images 222i and 222ii remain in place within the split GUI 226, in other words they remain in the same position that they were in within the GUI 16 (or within their position in the video game content 220) rather than being repositioned within the sub-GUI portion 224a now running (streaming, displaying etc.) content 220. As such, the user can continue playing the game when the GUI splits using their fingers in the same manner as before the splut. The sub-GUI portion 224b is shown streaming auxiliary content 205 such as an advertisement. The user can thus view advertisements without stopping the game or decide to pause the game to view the advertisement and even make a purchase via the sub-GUI portion 224b.

In an embodiment, the GUI 16 is provided by Extended Reality (XR) devices. Extended Reality (XR) is an umbrella term encapsulating Augmented Reality (AR) including Immersive Augmented Reality, Virtual Reality (VR) including Immersive Virtual Reality, Mixed Reality (MR) and variations and combination thereof as is known in the art. Thus, the term XR refers to all the foregoing variations.

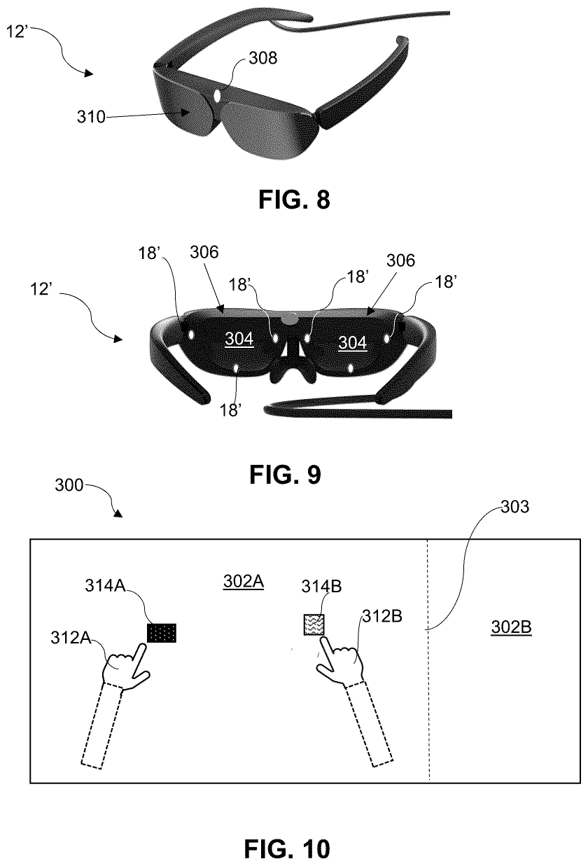

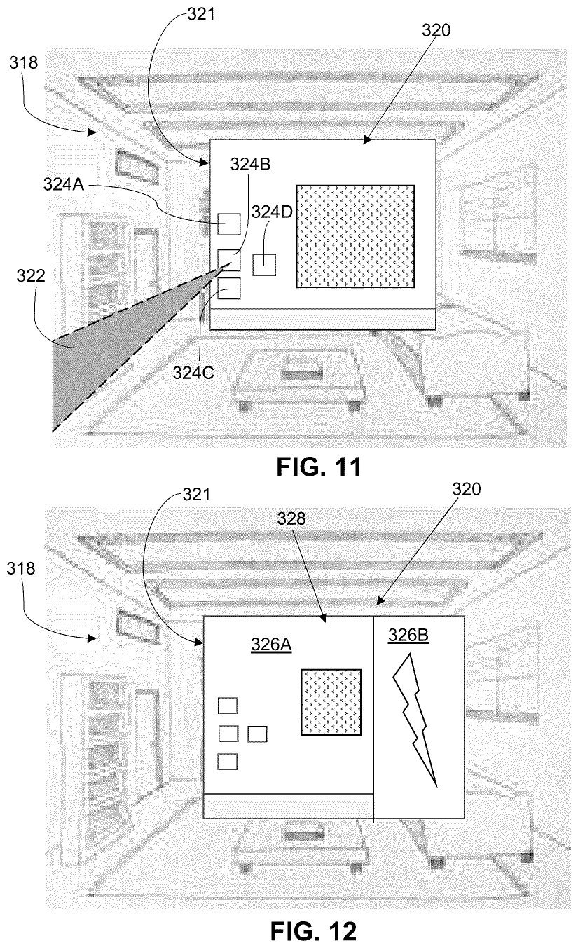

Turning to FIGS. 8 and 9, there is shown an example of XR or smart glasses devices 12′ that comprises a display interface for providing a virtual screen or GUI 300 as shown in FIG. 11. Certain contemporary XR glasses deliver a visual experience comparable to a 120″ TV of about 3 meters in front of the viewer. Examples of smart glasses are Google™ glasses, Nreal™ glasses, Nebula™ glasses, Viture™ glasses, Lenovo ThinkReality A3™ and many others.

As shown the viewer has the impression of seeing a virtual GUI 300 in front of them. The smart glasses system provide the viewer to interface with the virtual GUI much like a real physical screen with a GUI. For example, instead of physically touching a screen 14, their hand or finger moves in the direction of a portion of the virtual screen 300 that cannot be actually touch but a touch is emulated within an Expanded Reality context as is well understood in the art.

As shown in FIG. 10, the virtual GUI 300 can be split to provide a main sub-GUI portion 302A and an auxiliary sub-GUI portion 302B as indicated by phantom line 303 which delineates a border between two sub-GUI portions of GUI 300. Indeed, the virtual GUI 300 functions as the GUI 16 described herein. Thus, the description for user device 12 is applicable to the smart glasses device 12′ mutatis mutandis.

Turning back to FIG. 8, the smart glasses 12′ may include one or more cameras 18′ on the inner surface 304 thereof such as on the inner surface of the one or both lenses 306 in order to capture or record images including video images of the wearer's eyes. As mentioned before, the system controller 20 can analyze the images provided to determine a viewer type or status based on eye movement and shape indicators that are stored within the memory of the controller 20. Indeed, the device memory may include an application provide by the controller for this analysis. Of course, the cameras 18′ can also provide for command inputs input as described in U.S. Ser. No. 17/443,563 such as a cursor on the GUI 300 that moves with the field of view orientation @ as described in U.S. Ser. No. 17/443,563 to move across sub-GUI portions.

With reference to FIG. 8, the smart glasses 12′ may include a camera 308 at an external portion 310 thereof as shown in order to capture the real hands of the user in the field of view of camera 308. XR images 312A and 312B of the user's hands is produced within the virtual GUI 300. In addition to the hands, images 312A and 312B may also include arms or portions thereof. The movement of the images 312A and 312B within or along the virtual GUI 300 is synchronized with the real time movement of the user's actual hands. As such, the user is provided with inputting commands via the movement of the images 312A and 312B which emulates how the user would use their actual hands on a touch screen For example, the virtual screen 300 has the appearance of being a given distance in front of them. The user has the impression of seeing an actual screen and therefore would intuitively want to touch control it in the same way they use their regular touch screens on their computer or tablet etc. The user would thus have the instinct due to intuitive habit to move their hands towards the virtual screen 300 and in essence would be moving their hands in front of their XR glasses into emptiness. Indeed, they would not even see their hands. Therefore, the camera 308 captures the hand movement (including fingers and may also include arms or portions thereof if desired) and transfers the images to the device and/or system controller which execute alone or in combination the computer implementable step of providing the images 312A and 312B in front of the virtual GUI 300 so that the user can have the visual sensation that they are actually moving their hands along an actual screen but it is rather that the images 312A and 312B are emulating the movement of their actual hands along the virtual screen 300. Therefore, touch like movements of a user's hands trigger real input commands. The user can via their real hand movements guide their hand images 312A and 312B along the virtual screen 300.

In one example, the user wants to touch a given virtual icon 314A or 314B and brings their real hands to where they see this virtual icon on their virtual screen and this is captured by the external camera which transfers the real image to the controller (device, system or both) and which produces an XR image (312A, 312B) of their hands in the virtual GUI 300 giving the visual impression of hands in front of the screen 300. The user guides the virtual hand image (312A, 312B) with their real hand movements. As the user makes the movement of touching the virtual icon (314A, 314B) with their real hand, this is emulated by the XR hand image (312A, 312B) and this provides an input command to that icon (314A, 314B).

With reference to FIG. 11, the smart glasses 12′ provide for mixing the real environment 318 with a virtual image 320. As such, the user can still see the ambient environment 318 when they are wearing their smart glasses 12′ along with an XR GUI 320 that appears to be floating within the real environment 318 and overlying a portion thereof. Once again, the user will move their real arms and hands (schematically represented here by element 322) towards one or more input images (e.g. 324A, 324B, 324C, 324D) within the GUI 320 in order to input a command similarly to the way they would use a touch screen. The external camera 308 captures the hand movements of the user. The device and/or system controller execute the computer implementable step of building a cartesian table of the virtual screen 320 as well as of the space 321 in the ambient environment 318 occupied by the virtual screen 320. The device and/or system controller executes the computer implementable step of creating a correspondence between given coordinates along the cartesian table of the space 321 along which the hand position overlies and executes a touch control movement and the corresponding coordinates along the cartesian table of the virtual screen. In this way, when the user moves their hand to touch click the virtual screen 320 floating in the ambient environment 318 in front of them, the camera 308 captures the movement of their hands and the controller (of the device and/or system) provides for “seeing” what the user sees via the foregoing correspondence synchronization, namely, the controller determines that the user's hand is trying to touch click icon 324B and therefore provides for this input command to be executed in the same way a user would execute the command on a real touch screen.

Indeed, the foregoing can also be used in the example of FIG. 10, and as such, the user may not see images of their hands, but the controller (of the device and/or system) can determine the position of their hands vis-à-vis the virtual screen 300 by creating a cartesian table in the space of the ambient environment of where the screen would be positioned since the user has the visual sense that the screen 300 is in front of them within their virtual environment.

Thus, a condition of the user in the examples related to FIGS. 10 and 12 is the movement of the hands of the user including in certain cases the movement of their fingers and even their arms.

Turning now to FIG. 12, and as previously mentioned, the GUI 320 can be split/divided into two sub-GUI portions 326A and 326B thereby defining a multiple GUI display 328 occupying space 321. Moreover, and as shown in FIG. 25, the user can via hand virtual touch control (see 322) as described hereinabove undock one of the two sub-GUI portions, 326B from the multiple GUI display 328 and move it such that it appears to be moving within the ambient environment 318. Therefore, one sub-GUI portion 326A virtually occupies a space 321′ within the ambient environment 318 and the other sub-GUI portion 326B virtually occupies a space 321″ within the ambient environment 318.

Turning to FIG. 13 and with general reference to the description herein regarding FIG. 5, there is shown at step (i) a multiple window display 330 on a GUI host or platform 332 comprising two sub-window portions 334A and 334B. As previously described, the user can undock a given sub-window portion, such as 334B, for example, as shown in step (ii). By moving the undocked sub-window portion 334B over the sub-window portion 334A as shown at step (iii), the controller (device and/or system) executes the computer implementable step of causing the sub-window portion 334B to be ingested by or inserted in sub-window portion 334A and thereby occupying a part thereof as shown at step (iv) and in this way the sub-window portion 334A together with the sub-window portion 334B inserted therein provide a multiple window display. Of course, the user can extricate the sub-window portion from the sub-window 334A by a user input command therefor such as finger tap and slide movement for example or a mouse click and slide as another example.

Turning now to FIG. 14, the term splitting or dividing a GUI or a media window as provided herein also includes resizing an GUI/window by progressively decreasing the width or length thereof and simultaneously progressively increasing the width or length of a new GUI/window which will share the space taken by the original GUI/window to a predetermined size of the original GUI/Window and new GUI/Window.

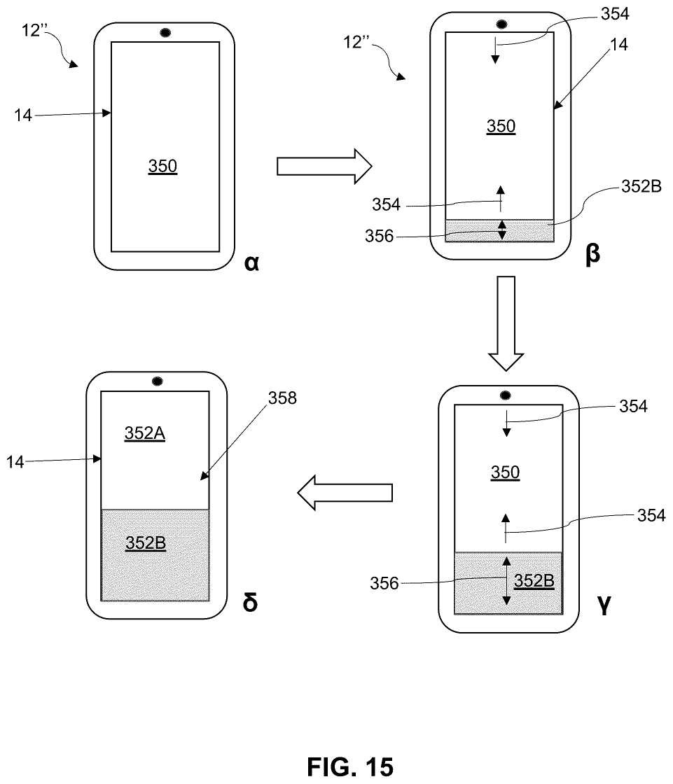

FIG. 15 shows a device 12″ such as a mobile device with a display screen 14 displaying a GUI 350 at step (a) which spans the width and length of the screen 14 in this example. When the GUI is 350 is split into sub-portions thereof, the new GUI sub-portion 352B appears as along a sliver of the screen 14 concurrently decreasing by the same sliver the original GUI 350 and progressively increases in size (along its length or height in this example) correspondingly progressively decreasing the size of the original GUI 350 (along its length or height in this example) as shown in steps (B) and (y) and as indicated by the inward arrows 354 which represent a decrease in size and the outward arrows 356 which represent an increase in size. The foregoing mutual resizing occurs in one quick swoop until the resulting multiple GUI display 358 is created which is the size of the original GUI 350 at step (a) but now having been split within the same boundary frame 360 between two sub-portions, namely sub-GUI portion 352A (which is the original GUI 350 displaying the original content thereof in a decreased sized version) and sub-GUI portion 352B which is the new GUI.

In another embodiment shown in FIGS. 16 and 17, the camera 18 of the user device 12 (smart TV, tablet, etc.) captures images the hand H movements of the user U and the user may click in the air E at distance A from the smart TV 12 as shown in FIG. 29. Their finger and/or hand H points in a given direction θ of the of the GUI 16. Indeed, as shown in FIG. 16, the user U is emulating the hand movement H′ of clicking on an input command image 400b. Therefore, instead of tapping on the screen 14 to touch click on an icon or a thumbnail 400a, 400b, 400c, 400d, the user does this in movement in the space E in front of their eyes at a distance A from the screen 14 (i.e. by not actually touching the screen). As such, the disclosure provides for modulating user commands via command input images displayed on a graphical user interface (GUI) based on a hand and/or finger direction along with hand and/or finger movement (such as screen touch or finger click movement on a regular screen) relative to the displayed command input images and the GUI. The system and/or device controller or the synergistic combination thereof perform computer implementable steps similar to those described in U.S. Ser. No. 17/443,563 yet, instead of using eye orientation, hand/finger orientation is monitored in combination with hand/finger movement.

Thus, this system provides for capturing real time images of the user's hand/or finger. The computer implementable steps comprise: determining a respective position for each of the command input images displayed on the graphical user interface; receiving real time captured images of the hand and/or finger of the user; separating the graphical user interface into interface portions thereof; determining in real time a general hand/finger orientation of the user based on the real time captured images; determining a real-time correlation between the determined general hand/finger orientation and one or more of the interface portions thereby determining a pointing direction of the user and one or more real-time interface portions being pointed to; and determining in real-time if the one or more interface portions pointed to contain one or more of the command input images. When the user inputs a user command via a selected one of the command input images, the following computer implementable steps are executed by the controller: determining in real time if the selected command input image is positioned within the one or more pointed to interface portions or if the selected command input image is not positioned within the one or more pointed to interface portions; allowing the user command to be processed if the selected command input image is positioned within the one or more pointed to interface portions; and preventing the user command to be processed if the selected command input image is not positioned within the one or more pointed interface portions.

User input commands include voice commands, movement commands and the like. In one example, when the user moves their hand or their finger to emulate a command such as touch or a click the user input command is processed for the pointed to input command image.

Thus, the user U points in the space E in front of them in the direction θ an icon 400b on the GUI with their hand H which emulates a click movement to run the program of this icon. Alternatively, the user points to an icon 400b and uses another input command such as their voice to run the program.

In the cases where the user's eye orientation is being used ϕ, as described in U.S. Ser. No. 17/443,563, the hand or finger clicks or touch screen movements in the air E captured by the camera's FOV 240 are indicative of input commands to run the program of the input command image.

In certain cases, when the GUIs herein are split into sub-portions thereof to simultaneously display independent content provided by at least one third party server, the controller 20 may request prior to GUI splitting for the third party server or servers to run the auxiliary content on the user device in order to avoid latency issues of having one sub-GUI portion displaying content while the other sub-GUI is waiting for content to be displayed. As such, content in both or more sub-GUIs are simultaneously displayed.

It is to be understood that independent modulation of one or more of the sub-GUI portions of a given multiple GUI display or of one or more of the sub-window portions of a given multiple window display includes non-limiting example of locking one sub-portion while the other sub-portion remain dynamic, wherein “locking” includes without limitation a stopped/paused stream, a muted stream, a non-scrollable page, and/or the inability to receive input commands and the like and wherein “remaining dynamic” includes without limitation, a continuous stream, an unmuted stream, a scrollable page, and/or the ability to receive input commands as the like.

The various features described herein can be combined in a variety of ways within the context of the present disclosure so as to provide still other embodiments. As such, the embodiments are not mutually exclusive. Elements of the embodiments and examples discussed can be combined within the context of the disclosure as those having skill in the art will readily appreciate. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A system for modulating a graphical user interface (GUI), the system comprising:
a user device comprising a device controller with an associated memory and a display interface for displaying the GUI, the GUI defining a frame boundary thereof further defining a GUI size, the GUI comprising content displayed via the display interface; and
a system controller in communication with the user device, the system controller having a processor with an associated memory of processor executable code for being executed by the system controller or for being downloaded into the memory of the user device controller to be executed thereby or to be executed synergistically by a combination of the system controller and the device controller, wherein execution of the processor executable code by the system controller or by the device controller or by the combination thereof synergistically provides for the system controller or the device controller or the combination thereof with performing computer-implementable steps comprising:
detecting a real-time status selected from the group consisting of a device user status, a device status, an auxiliary device status, a content status, and a combination thereof;
determining the detected real-time status based on status criteria stored within the memory of the system controller and/or the user device; and
modulating the GUI on the basis of the determined real-time status.

2. A system according to claim 1, wherein the step of modulating comprises a step selected from the group consisting of:
splitting the GUI into two or more sub-GUI portions positioned within the GUI frame boundary and providing for the two or more sub-GUI portions to simultaneously display respective content stored within the user device and/or hosted by the system controller and/or a same or different remote host controllers in communication with the user device;
modulating the displayed content of the GUI;
modulating the displayed content of the two or more sub-GUI portions following the step of splitting the GUI; and
a combination thereof.

3. A system according to claim 2, wherein following the step of splitting the GUI, the step of modulating further comprises a step selected from the group consisting of:
resizing at least one of the two or more sub-GUI portions;
re-configuring at least one of the two or more sub-GUI portions;
removing at least one of the two or more sub-GUI portions; and
combination thereof.

4. A system according to claim 1, wherein the user device comprises a sensor for detecting a user in detectable proximity to the device thereby detecting the real-time user status.

5. A system according to claim 4, wherein the sensor detects a sound of the user within the detectable proximity.

6. A system according to claim 1, wherein the user device comprises smart glasses to be worn by the user, the smart glasses comprising at least one camera at an inner surface thereof for capturing images of an eye or eyes of the user, wherein the user status comprises an eye condition of the user.

7. A system according to claim 6, wherein the eye condition status of the user comprises a position of the eyes of the user, a direction of the eyes of user, a movement of the eyes of the user, a position of the eyelids of the user and a combination thereof.

8. A system according to claim 6, wherein the smart glasses further comprise an outer camera positioned at an outer surface of thereof for capturing hand movements of the user.

9. A system according to claim 8, wherein the device user condition comprises hand movements of the user

10. A system according to claim 1, wherein the user device comprises a camera for capturing images of the device user within a field of view (FOV) of the camera to detect the real-time user status.

11. A system according to claim 10, wherein the device user status is selected from the group consisting of a user condition status, a user facial status, a user type status and a combination thereof.

12. A system according claim 11, wherein the condition status is selected from the group consisting of a presence of the user within the FOV of the camera, a movement of the user within the FOV of the camera, a position of the user within the FOV of the camera, a size of the user within the FOV of the camera, an eye condition status of the user within the FOV of the camera and a combination thereof.

13. A system according to claim 12, wherein the position of the user is selected from a position of the body of the user, a configuration of the body of the user and a combination thereof.

14. A system according to claim 12, wherein the eye condition status of the user comprises a position of the eyes of the user, a direction of the eyes of user, a movement of the eyes of the user, a position of the eyelids of the user and a combination thereof.

15. A system according to claim 11, wherein the determining of the real-time detected user facial status comprises facial recognition of the user and wherein the stored status criteria comprises stored user profiles including registration of the face of the user for facial recognition.

16. A system according to claim 11, wherein the facial status of the user is selected from the groups consisting of an eye condition status of the user, a size of the face of the user, a position of the face of the user, a facial type of the user combinations thereof.

17. A system according to claim 11, wherein the user type status is selected from the group consisting of an age type status, a gender type status, a size type status, a species type status and combinations thereof.

18. A system according to claim 1, wherein the device status is selected from the group consisting of: a position of the device, a location of the device, a motion of the device, a use of the device, and combinations thereof.

19. A system according to claim 18, wherein the use of the device is selected from the group of the device displaying content via the display interface, receiving user input commands.

20. A system according to claim 1, wherein the auxiliary device status is selected from the group consisting of an established communication between an auxiliary device and the user device, an input command to the user device via an auxiliary device, and a combination thereof, wherein the auxiliary device is a physical device and/or a virtual device.

21. A system according to claim 2, wherein modulating the displayed content is selected from the group consisting of pausing streamed content, switching from one given streamed content to another given streamed content, rewinding streamed content, fast-forwarding streamed content, recalling previously streamed content to be streamed again in real-time and combinations thereof.

22. A system according to claim 2, wherein when the GUI is split into the two or more sub-GUI portions positioned within the GUI frame boundary it defines a multiple display GUI, wherein the computer-implementable steps comprise:
undocking a selected one of sub-GUI portions from the multiple display GUI thereby spatially separating the undocked sub-GUI portion therefrom, the undocked sub-GUI portion defining its own separate boundary frame and being selectively movable along the display interface.

23. A system according to claim 22, wherein the undocking is performed via a user input command thereof.

24. A system according to claim 2, wherein the GUI comprises media content display window defining the boundary frame and being displayed on a host graphical user interface and the two or more sub-GUI portions comprise two or more sub-window portions, wherein the splitting step comprises splitting the media content display window into the two or more sub-window display portions positioned within the frame boundary of the media display window.

25. A system according to claim 24, wherein when the media window is split into the two or more sub-window portions positioned within the frame boundary thereof it defines a multiple display window, wherein the computer-implementable steps comprise:
undocking a selected one of the sub-window portions from the multiple display window thereby spatially separating the undocked sub-window portion therefrom, the undocked sub-window portion defining its own separate boundary frame and being selectively movable along the host graphical user interface.

26. A system according to claim 2, wherein the GUI prior to the splitting displays video game content with game input control images for receiving finger real or virtual touch input commands for game control wherein the input control images are displayed at respective given positions via the display interface, wherein the computer-implementable steps comprise maintaining the input control images at the same respective and given displayed positions via the display interface following the splitting of the GUI thereby overlying one or more of the two or more sub-GUI portions.

27. A system according to claim 2, wherein the GUI comprises a framework, the computer-implementable steps further comprising:
modulating the framework of the GUI thereby providing for the splitting thereof into the two or more sub-GUI portions and for providing for the two or more sub-GUI portions to simultaneously display the respective content.

28. A system according to claim 2, wherein splitting the GUI into two or more sub-GUI portions positioned within the GUI frame boundary comprises decreasing the size of the GUI while correspondingly replacing the decrease in size by an increase in size of at least one new GUI wherein the decreased GUI comprises one of the two or more sub-GUI portions and the at least one new GUI comprises the other of the two or more sub-GUI portions.

29. A system according to claim 2, wherein splitting the GUI into two or more sub-GUI portions positioned within the GUI frame boundary comprises inserting at least one new GUI within the GUI causing the GUI to be correspondingly reconfigured, wherein the reconfigured GUI comprises one of the two or more sub-GUI portions and the at least one new and inserted GUI comprises the other of the two or more sub-GUI portions.
